(19) United States
(12) Patent Application Publication
(10) Pub. No.: US 2026/0122675 A1
(43) Pub. Date: Apr. 30, 2026

(54) Method and Apparatus for Enabling a Coordinated Transmission in a Wireless Mesh Network

(71) Applicant: Telefonaktiebolaget LM Ericsson (publ), Stockholm (SE)

(72) Inventors: Jan Christoffersson, Luleå (SE); Mårten Ericson, Gammelstad (SE); Stefan Wänstedt, Luleå (SE)

(21) Appl. No.: 19/120,538

(22) PCT Filed: Oct. 14, 2022
(86) PCT No.: PCT/EP2022/078675

§ 371 Date: Apr. 11, 2025

(51) Int. Cl. H04W 74/0808; H04W 84/18

(52) U.S. Cl. CPC H04W 74/0808; H04W 84/18

(57) ABSTRACT

A method of enabling a coordinated transmission (REF) in a wireless mesh network for a transmission of a message from a source mesh node of the wireless mesh network to a destination node, wherein said wireless mesh network further comprises a plurality of intermediate mesh nodes for relaying said message from said source mesh node to said destination node, wherein the method comprises the step of broadcasting, by said source mesh node, in said mesh network, a message intended for said destination node, wherein said message comprises coordination information enabling multiple intermediate mesh nodes in said wireless mesh network that receive said message to jointly perform, at a same time, a coordinated transmission towards said destination node.

### TECHNICAL FIELD

The present disclosure is generally related to the field of wireless communications and, more specifically, to coordinated transmissions of intermediate mesh nodes in a transmission from a source mesh node to a destination node in a wireless mesh network.

### BACKGROUND

Mesh networking is a key technology-agnostic enabler for Internet-of-Things, IoT, in the short wireless range space. Well-known technologies such as Wi-Fi and ZigBee have already standardized mesh support, and products that feature mesh networking are available on the market.

Another well known technology is Bluetooth. Typically, in a Bluetooth mesh network, the wireless mesh nodes are asynchronously deployed and can talk to each other directly when within coverage of each other. After provisioning, the network may start operating and does not require any centralized operation-no coordination is required and, as such, there is no single point of failure. A group of nodes can be addressed with a single command, making dissemination and collection of information fast and reliable.

The basic scenario for this disclosure is related to mesh nodes in a wireless mesh network. The mesh nodes in the mesh network may operate on a separate radio resources, for example Bluetooth resources, compared to the cellular, for example 5G, network. It may also be that the wireless mesh network operates on radio resources that are controlled by the cellular network such as Side Link, SL.

A wireless mesh network may be deployed such that a source mesh node broadcasts any data to any adjacent wireless mesh nodes. These adjacent wireless mesh node may decode and subsequently relay the data to other adjacent wireless mesh nodes. This is typically called “Flooding”.

To avoid that wireless mesh nodes, that have already transmitted the data, are retransmitting the same data once again, the relaying may be restricted. Several options exist to accomplish that particular effect. On top of that, a random delay may be introduced when different wireless mesh nodes forward the data to avoid collisions with other transmissions, thereby increasing the reliability of the transmission through the wireless mesh network.

In any case, when several wireless mesh nodes have data to transmit through wireless mesh network, the risk of congestion and collisions increases throughout the wireless mesh network increases.

### SUMMARY

It is an object of the present disclosure to provide for a method of enabling a coordinated transmission in a wireless mesh network for the transmission of a message from a source mesh node to a destination node. Further objects include associated methods as well as associated mesh nodes and computer program products.

In a first aspect of the present disclosure, there is provided a method of enabling a coordinated transmission in a wireless mesh network for a transmission of a message from a source mesh node of the wireless mesh network to a destination node. The wireless mesh network further comprises a plurality of intermediate mesh nodes for relaying said message from said source mesh node to said destination node. The method comprises the step of broadcasting, by said source mesh node, in said mesh network, a message intended for said destination node.

Here, the message comprises coordination information enabling multiple intermediate mesh nodes in said wireless mesh network that receive said message to jointly perform, at a same time, a coordinated transmission towards said destination node. Preferably, the destination node is also comprised by the wireless mesh network.

The inventors have found that it might be beneficial if multiple intermediate mesh nodes coordinate their transmissions. This may reduce the risk of congestion and collisions within the wireless mesh network, and may increase the range of the transmission. The coordination is accomplished in that the multiple intermediate mesh nodes perform the coordinated transmission at the same time, i.e. these mesh nodes will transmit the same data at the same time.

In other words, instead of continuing multi-hops over the wireless mesh network, a coordinated transmission may be initiated at some point in time to make the overall transmission of data more efficient. The above may include specifying a number of hops in the mesh network and/or also specification of time when the cooperative transmission is to be carried out.

The source mesh node triggering the procedure may insert a header containing the relevant information, i.e. the coordination information. When other wireless mesh nodes receive the mesh transmissions, they may update the header and either do additional mesh transmissions or a cooperative transmission. The above is elucidated in more detail with respect to the figures.

In an example, the coordination information enables multiple intermediate mesh nodes in said wireless mesh network that receive said message at a same hop count from said source mesh node to perform said coordinated transmission.

The source mesh node may sent the message to its adjacent mesh nodes. These adjacent mesh nodes may, in turn, relay the message to their adjacent mesh nodes, etc. The message may thus be transmitted over several so-called “hops”. In an advantageous embodiment, all intermediate mesh nodes that are the same hop-count away from the source mesh node may jointly perform the coordinated transmission towards the destination node.

To do so, the source mesh node may include the number of hops in the coordination information of the particular message, such that the intermediate nodes know whether they are to be involved in the coordinated transmission. Each intermediate node that receives the particular message may decrease the number of hops by one “1”, until the number of hops reaches zero “0”. This indicates that the coordinated transmission is to start.

An alternative way is that a particular parameter, for example a hop count, is increased by one each time an intermediate node receives the particular message. The coordinated transmission may then be applicable for those intermediate mesh nodes for which this particular parameter reaches a predetermined threshold, or for which this particular parameter is within a predetermined range, for example three to five hops away from the source mesh node or something alike.

The general concept of the above described example is that the coordination information may comprise relative information. Each intermediate mesh node may amend the relative information until the amended relative information triggers the coordinated transmission. For example, the hop-count reaching zero may trigger the intermediate mesh node to perform the coordinated transmission.

Another encompassed option is that the coordination information comprises absolution information. Absolute information may, for example, comprise the actual time at which the coordinated transmission is to occur.

In another example, the coordination information is any of:
a time-to-next mesh transmission indicating to said intermediate mesh nodes when to relay said message;
a time-to-cooperative mesh transmission indicating to said intermediate mesh nodes when to simultaneously relay said message;
range of number of hops away from the source mesh node;
a seed for a random number generator for indicating a delay in relaying said message;
a number of mesh transmissions indicating a number of hops for said message from said source mesh node before performing said coordinated transmission;
a time-to-live counter indicating a remainder of a number of hops for said message from said source mesh node before performing said coordinated transmission;
a trigger to predetermined coordination information indicating how to jointly perform said coordinated transmission.

The time-to-next mesh transmission may indicate to the intermediate mesh nodes when to relay the message, i.e. at the same time. The time-to-next mesh transmission may, for example, be relative to when the first transmission is transmitted or received, or be relative to some other reference such as a system frame number.

Another option is that the time-to-next mesh transmission is absolute for example by making a reference to the actual time.

The time-to-cooperative mesh transmission indicated when an intermediate mesh node is to be involved in jointly transmitting the message towards the destination node. The time-to-cooperative mesh transmission may be relative to when the first transmission is transmitted/received or be relative to some other reference such as a system frame number. Another option is that the time-to-cooperative mesh transmission is absolute for example by making a reference to the actual time.

In a further example, the method further comprises the step of:
introducing, by said source mesh node, said coordination information in a header of said message.

The payload of the message may be encrypted such that the intermediate nodes may not be able to decrypt it. The header of a message may not be encrypted thereby enabling any intermediate mesh node to receive the coordination information and to act accordingly.

In a further example, the destination node is an access node of a telecommunication network arranged for operating in said wireless mesh network and arranged for providing access to said telecommunication network.

This example provides for an example in which the wireless mesh network may be able to extend its range to an access node of the telecommunication network by jointly performing, i.e. simultaneously, the coordinated transmission. The inventors have found that the coverage area of a wireless mesh network may not always overlap with the coverage area of the access node. The coordinated transmission may extend the coverage area of the wireless mesh network temporarily, i.e. for that particular transmission, such that the access node may be reached.

In a second aspect of the present disclosure, there is provided a method of performing a coordinated transmission in a wireless mesh network for a transmission of a message from a source mesh node of the wireless mesh network to a destination node. Here, the wireless mesh network further comprises a plurality of intermediate mesh nodes for relaying said message from said source mesh node to said destination node.

The method comprises the step of receiving, by an intermediate mesh node of said wireless mesh network, said message broadcasted by said source mesh node and intended for said destination node. The message comprises coordination information enabling multiple intermediate mesh nodes in said wireless mesh network that receive said message to jointly perform, at a same time, said coordinated transmission towards said destination node.

The method further comprises the step of performing, by said intermediate mesh node, said coordinated transmission based on said coordination information.

It is noted that advantages of the examples of the different methods with respect to the first aspect of the present disclosure are also applicable to the methods with respect to the second aspect of the present disclosure.

The method in accordance with the second aspect of the present disclosure is directed to the intermediate mesh node. The coordination information enables such an intermediate node to perform a coordinated transmission. It informs the intermediate node whether, and if so, when to perform the coordinated transmission.

In an example, the coordination information enables multiple intermediate mesh nodes in said wireless mesh network that receive said message at a same hop count from said source mesh node to perform said coordinated transmission.

In a further example, the coordination information is any of:
a time-to-next mesh transmission indicating to said intermediate mesh nodes when to relay said message;
a time-to-cooperative mesh transmission indicating to said intermediate mesh nodes when to simultaneously relay said message;
a seed for a random number generator for indicating a delay in relaying said message;
a number of mesh transmissions indicating a number of hops for said message from said source mesh node before performing said coordinated transmission;
a time-to-live counter indicating a remainder of a number of hops for said message from said source mesh node before performing said coordinated transmission;
a trigger to predetermined coordination information indicating how to jointly perform said coordinated transmission.

In an example, the coordination information is comprised in a header of said message.

In yet another example, the destination node is an access node of a telecommunication network arranged for operating in said wireless mesh network and arranged for providing access to said telecommunication network.

In a further example, the method further comprises the step of:
determining, by said intermediate node, that said relaying of said message by said intermediate node is to be performed using a coordinated transmission, based on said coordination information.

In a third aspect of the present disclosure, there is provided a source mesh node arranged for enabling a coordinated transmission in a message wireless mesh network for a transmission of a message from said source mesh node of the wireless mesh network to a destination node. The wireless mesh network further comprises a plurality of intermediate mesh nodes for relaying said message from said source mesh node to said destination node. The source mesh node comprises a processor and a memory, wherein the memory containing instructions executable by said processor whereby said source mesh node is arranged for broadcasting, in said mesh network, a message intended for said destination node.

Here, the message comprises coordination information enabling multiple intermediate mesh nodes in said wireless mesh network that receive said message to jointly perform, at a same time, a coordinated transmission towards said destination node.

Preferably, the destination node is a destination mesh node comprised by the wireless mesh network.

It is noted that advantages of the examples of the different methods with respect to the first aspect of the present disclosure are also applicable to the source mesh node with respect to the third aspect of the present disclosure.

In an example, the coordination information enables multiple intermediate mesh nodes in said wireless mesh network that receive said message at a same hop count from said source mesh node to perform said coordinated transmission.

In a further example, the coordination information is any of:
a time-to-next mesh transmission indicating to said intermediate mesh nodes when to relay said message;
a time-to-cooperative mesh transmission indicating to said I intermediate mesh nodes when to simultaneously relay said message;
a seed for a random number generator for indicating a delay in relaying said message;
a number of mesh transmissions indicating a number of hops for said message from said source mesh node before performing said coordinated transmission;
a time-to-live counter indicating a remainder of a number of hops for said message from said source mesh node before performing said coordinated transmission;
a trigger to predetermined coordination information indicating how to jointly perform said coordinated transmission.

In yet another example, the source mesh node is further arranged for:
introducing, by said source mesh node, said coordination information in a header of said message.

In a fourth aspect of the present disclosure, there is provided an intermediate mesh node arranged for performing a coordinated transmission in a wireless mesh network for a transmission of a message from a source mesh node of the wireless mesh network to a destination node. The wireless mesh network further comprises a plurality of intermediate mesh nodes for relaying said message from said source mesh node to said destination node. The source mesh node comprising a processor and a memory, said memory containing instructions executable by said processor whereby said source mesh node is arranged for receiving said message broadcasted by said source mesh node and intended for said destination node.

The message comprises coordination information enabling multiple intermediate mesh nodes in said wireless mesh network that receive said message to jointly perform, at a same time, a coordinated transmission towards said destination node.

The source mesh node is further arranged for performing said coordinated transmission based on said coordination information.

It is noted that advantages of the examples of the different methods with respect to the first aspect of the present disclosure are also applicable to the intermediate mesh node with respect to the fourth aspect of the present disclosure.

In an example, the coordination information enables multiple intermediate mesh nodes in said wireless mesh network that receive said message at a same hop count from said source mesh node to perform said coordinated transmission.

In another example, the coordination information is any of:
a time-to-next mesh transmission indicating to said intermediate mesh nodes when to relay said message;
a time-to-cooperative mesh transmission indicating to said intermediate mesh nodes when to simultaneously relay said message;
a seed for a random number generator for indicating a delay in relaying said message;
a number of mesh transmissions indicating a number of hops for said message from said source mesh node before performing said coordinated transmission;
a time-to-live counter indicating a remainder of a number of hops for said message from said source mesh node before performing said coordinated transmission;
a trigger to predetermined coordination information indicating how to jointly perform said coordinated transmission.

In a further example, the coordination information is comprised in a header of said message.

In yet another example, the intermediate mesh node is further arranged for:
determining that said relaying of said message by said intermediate node is to be performed using a coordinated transmission, based on said coordination information.

In yet another aspect of the present disclosure there is provided a computer program product comprising a computer readable medium having instructions stored thereon, which instructions, when loaded, cause a source mesh node to implement a method in accordance with any of the examples provided above.

In a further aspect of the present disclosure there is provided a computer program product comprising a computer readable medium having instructions stored thereon, which instructions, when loaded, cause an intermediate mesh node to implement a method in accordance with any of the examples provided above.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

The above and other aspects of the disclosure will be apparent from and elucidated with reference to the examples described hereinafter.

### BRIEF DESCRIPTION OF THE DRAWINGS

FIG. 1 discloses a wireless mesh network including gateways to forward message from the mesh network to a cellular network;

FIG. 2 discloses a wireless mesh network wherein a source mesh node initiates a broadcast;

FIG. 3 discloses a wireless mesh network visualizing a second hop corresponding to a source mesh node that has initiated a broadcast;

FIG. 4 discloses a high level example of multiple intermediate mesh nodes that coordinate their transmission towards an access node of a cellular network;

FIG. 5 discloses an overview of a method in accordance with the present disclosure;

FIG. 6 discloses an example of a source mesh node in accordance with the present disclosure;

FIG. 7 discloses an example of an intermediate mesh node in accordance with the present disclosure.

### DETAILED DESCRIPTION

It is noted that in the description of the figures, same reference numerals refer to the same or similar components performing a same or essentially similar function.

A more detailed description is made with reference to particular examples, some of which are illustrated in the appended drawings, such that the manner in which the features of the present disclosure may be understood in more detail. It is noted that the drawings only illustrate typical examples and are therefore not to be considered to limit the scope of the subject matter of the claims. The drawings are incorporated for facilitating an understanding of the disclosure and are thus not necessarily drawn to scale. Advantages of the subject matter as claimed will become apparent to those skilled in the art upon reading the description in conjunction with the accompanying drawings.

The ensuing description above and below provides preferred exemplary embodiment(s) only, and is not intended to limit the scope, applicability or configuration of the disclosure. Rather, the ensuing description of the preferred exemplary embodiment(s) will provide those skilled in the art with an enabling description for implementing a preferred exemplary embodiment of the disclosure, it being understood that various changes may be made in the function and arrangement of elements, including combinations of features from different embodiments, without departing from the scope of the disclosure.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, electromagnetic, or a combination thereof. Additionally, the words “herein,” “above,” “below,” and words of similar import, when used in this application, refer to this application as a whole and not to any particular portions of this application. Where the context permits, words in the Detailed Description using the singular or plural number may also include the plural or singular number respectively. The word “or,” in reference to a list of two or more items, covers all of the following interpretations of the word: any of the items in the list, all of the items in the list, and any combination of the items in the list.

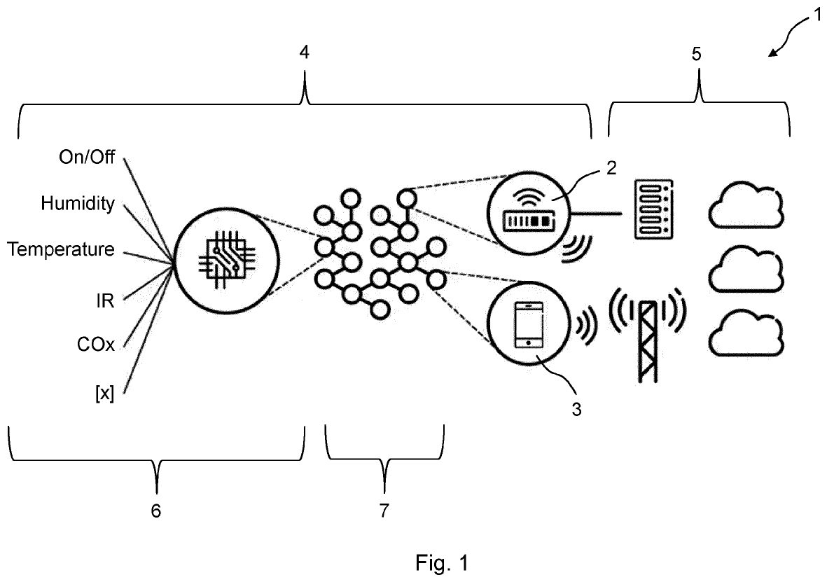

FIG. 1 discloses a wireless mesh network including gateways to forward message from the mesh network to a cellular network.

Mesh networking is a technology-agnostic enabler for Internet-of-Things, IoT, in the short range space. Well-known technologies such as Wi-Fi and ZigBee have standardized mesh support, and products that feature mesh networking are available on the market.

A capillary network is a Local Area Network, LAN, that uses short-range radio-access technologies to provide groups of devices with wide area connectivity. Capillary networks therefore extend the range of the wide area mobile networks to constraint devices. FIG. 1 illustrates, as an example, a Bluetooth capillary gateway concept 1. As a capillary radio, Bluetooth standardizes the messages and behaviours of a variety of user scenarios that require sensing and/or actuation commands for constraint nodes. The relaying of these commands over multiple hops in the mesh also enables communication between nodes that are not within direct radio reach of each other.

The presence of capillary gateways such as smartphones 3 and/or proxy nodes 2 that support both Bluetooth and cellular connectivity in the mesh area network 4 extends the accessibility of extremely low-power, storage and memory constrained devices into the core network up and to the cloud. The capillary gateways 2, 3 may thus provide connectivity towards a core network of a telecommunication network as indicated with reference numeral 5.

The wireless mesh network 4 may consist of a plurality of mesh nodes, for example sensors and actuators as indicated with reference numeral 6 and other types of intermediate mesh nodes 7.

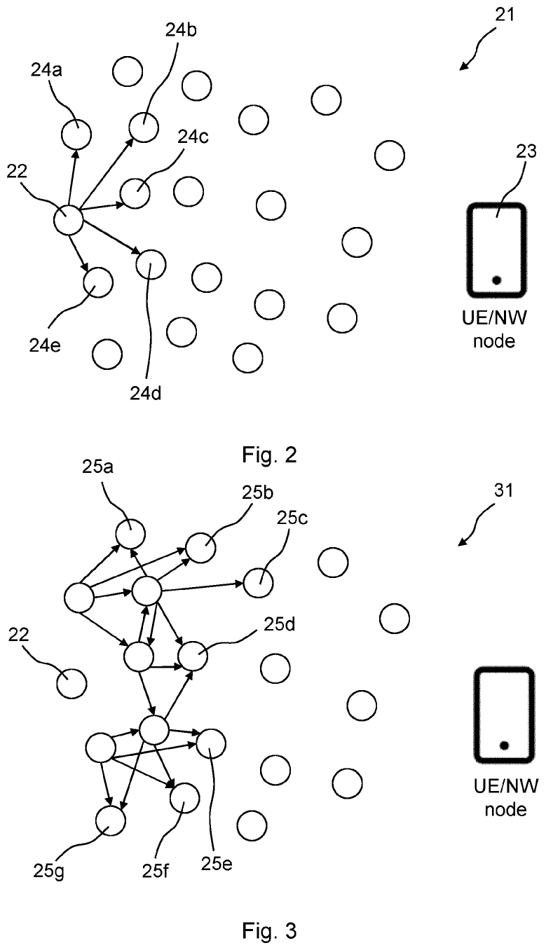

FIG. 2 discloses a wireless mesh network 21 wherein a source mesh node 22 initiates a transmission towards a destination node 23.

The destination node 23 may be part of the wireless mesh network 21 but this is not necessarily the case. The destination node 23 may, as an alternative, operate in accordance with a different wireless technology, like Wi-Fi, 4G/5G, or anything alike. In the latter case, the wireless mesh nodes that perform the coordinated transmission should be able to also operate in accordance with that particular wireless technology.

FIG. 2 visualizes a so-called one-hop. That is, the intermediate nodes 24a, 24b, 24c, 24d and 24e are the intermediate nodes that are one-hop away from the source mesh node 22. These intermediate nodes are arranged to relay the message from the source mesh node further into the mesh network.

The message comprises coordination information enabling multiple intermediate mesh nodes in the wireless mesh network 21 that receive that message to jointly perform, at a same time, a coordinated transmission towards the destination node 23. That is, each of the intermediate mesh nodes 24a, 24b, 24c, 24d and 24e may relay the message at the same time. This extends to coverage area such that the relayed message may directly be received by the destination mesh node 23.

FIG. 3 discloses a wireless mesh network 31 visualizing a second hop corresponding to a source mesh node 22 that has initiated a broadcast.

As shown in FIG. 3, the number of intermediate nodes may increase for each hop-count. In this particular scenario, there are in total seven intermediate mesh nodes that are two-hops away from the mesh node. These seven intermediate nodes may perform the coordinated transmission towards the destination node 23 together, based on, or triggered by, the coordination information comprised by the message from the source mesh node 22.

The intermediate nodes may receive the broadcasted message in a first, second, third, etc. hop from the source mesh node. The wireless mesh network may use a certain mesh technology, like Bluetooth mesh or the like. Typically, the coordinated transmission is performed in the same technology, i.e. in the so-called “mesh”-technology.

However, the present disclosure is also directed to the concept that the intermediate mesh nodes have the capability of functioning as a gateway. In a specific example, the destination node is a base station of a telecommunication network. The base station of the telecommunication network may be equipped such that it can send and receive messages in the mesh network, like the Bluetooth mesh network. However, such a gateway function may also be implemented in the intermediate mesh node. Those intermediate mesh nodes may receive the broadcasted message in in the mesh network, using mesh networking technology, but may perform the coordinated transmission in a different technology. For example, the coordinated transmission may be performed in a telecommunication environment, i.e. a 4G or 5G environment. The benefit thereof is that the base station of the telecommunication network does not need to provide the gateway function. That function is transferred to each of the intermediate mesh nodes.

In essence, the coordinated transmission may be performed by gateway nodes, wherein the gateway nodes are comprised in the intermediate mesh nodes. A gateway node may then be defines as a node that is able to communicate with a first network, being the wireless mesh network, and a second network different to the first network, for example a telecommunication network.

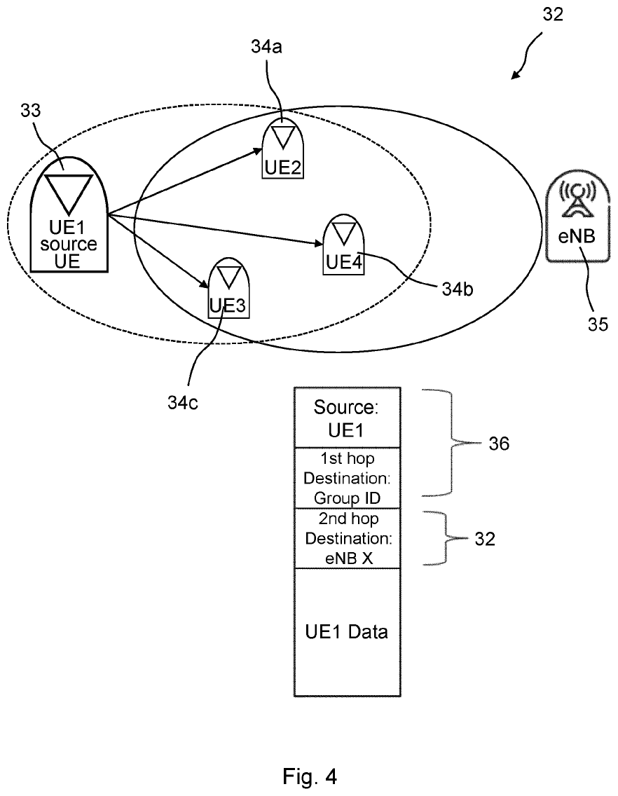

FIG. 4 discloses a high level example of multiple intermediate mesh nodes 34a, 34b, 34c of a wireless mesh network 32 that coordinate their transmission towards an access node of a cellular network.

In this particular case, the destination node 35 is an access node of a telecommunication network, wherein the access node 35 is also arranged to operate in the wireless mesh network 32.

The intermediate nodes 34a, 34b, 34c may form a so-called “group”, wherein the group of intermediate nodes will jointly transmit the message originating from the source mesh node 33 towards the destination node 35.

The groups may be pre-established or predefined, but may also be established during the transmission of the message throughout the wireless mesh network.

An example is that the source mesh node may identify which nodes are to be included in the group. The source mesh node may have specific information available, for example the location of the intermediate mesh nodes, and may decide itself which nodes are to be included in the group for the coordinated transmission towards the destination node.

The group may, for example, constitute of all intermediate mesh nodes involves in receiving the broadcasted message, or may constitute of those intermediate mesh nodes that are closely located to the destination node, or anything alike.

Another example is that the group is dynamically established during the process of broadcasting the message through the wireless mesh network. The broadcasted message may comprise an group identifier, or the like, and the intermediate nodes that receive such a message may decide themselves whether they are a part of the group or note based on the group identifier.

An even further example is that the group is dynamically established based on the coordination information present in the message. Any intermediate mesh node may decide itself whether it can aid in the coordinated transmission based on the coordination information. If so, the intermediate mesh node may decide to include itself to the group of intermediate mesh node that will perform the coordinated transmission.

A typical implementation of the message is shown at the bottom side of FIG. 4. Fields may be present to indicate the source of the message 36, i.e. the source mesh node 33, as well as the destination of the message for the first-hop, i.e. the group of intermediate nodes as indicated with the reference numerals 34a, 34b and 34c.

Finally, the present disclosure introduces a further field as indicated with reference numeral 37. This particular field indicates the destination of the second-hop, i.e. the destination node 35. This particular field may also form a trigger for the intermediate nodes of the second-hop to perform a coordinated transmission towards the destination node 35.

On top of the above, it is noted that it may be beneficial for a variety of reasons, if the destination node is aware that it receives a message that is associated with a coordinated transmission. As such, the source mesh node, or any of the intermediate mesh node, may include information in the message for informing the destination node that the message is associated with a coordinated transmission.

That information may, for example, be included in the payload of the message or in the header of the message.

One of the advantages is that the destination node is aware that the route back to the source mesh node may be troublesome given that a coordinated transmission was required to reach the destination node. If the destination node intends to send a message back to the source mesh node, it can then take pre-emptive measures to tackle this particular aspect.

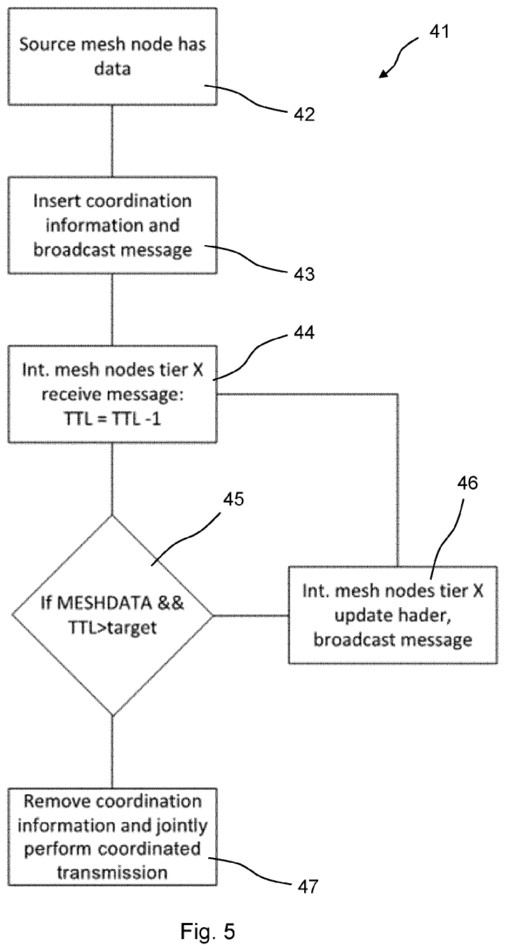

FIG. 5 discloses an overview of a method 41 in accordance with the present disclosure.

In method 41 starts when the source mesh node has data that it would like to transmit 42. The source mesh node may insert 43 the coordination information into that particular message before it broadcasts the message in to the wireless mesh network. The coordination information is, in this particular case, a Time To Live, TTL, indicator.

Intermediate mesh nodes that receive the message, amend 44 the TTL in that particular message. That is, they reduce the TTL by one.

Next, it is checked whether the TTL is above a particular target TTL. The target TTL forms the trigger for the coordinated transmission. If that's the case, the intermediate mesh nodes update the header of the message and broadcasts the message further into the network. This is indicated with reference numeral 46.

If that's not the case then the coordination information is removed, which is optional, and the coordinated transmission is performed, which is indicated by reference numeral 47.

The process of initiating a method to perform a coordinated transmission may be triggered for different reasons, some of which will be elucidated here below.

One of the reasons is that a path request process has failed. The source mesh node may initiate a path request procedure to the destination node. If that particular path request procedure does not succeed, it would indicate that no path can be established between the source mesh node and the destination node. For example, the source mesh node will not receive a path reply message in a certain time window, i.e. a time-out will occur, which is the indication that no path can be established. This could trigger the source mesh node to try again, but then in line with the method in accordance with the present disclosure, i.e. performing a coordinated transmission.

Another option is that the destination node always needs a coordinated transmission. The destination node may have a predetermined, or predefined, setting in which it indicates that it always needs a coordinated transmission. This could be, for example, the case for a base station in a telecommunication network, wherein it may be assumed that the base station is usually at a longer distance from the mesh network compared to the intermediate nodes of the mesh network. Once the source mesh node intends to send a message to the destination node, the source mesh node may determine that the destination node requires a coordinated transmission based on, for example, settings in the wireless mesh network, on the address of the destination node, on the type or identity of the destination node, or anything alike.

Yet a further option relates to an established path between the source mesh node and the destination node, but that path—for whatever reasons—has failed. Some intermediate nodes may become unavailable, some connections may become unstable or anything alike. In that case, the source mesh node may receive an acknowledgement indicating that the destination node could not be reached, indicating to the source mesh node to try again but with a coordinated transmission scheme.

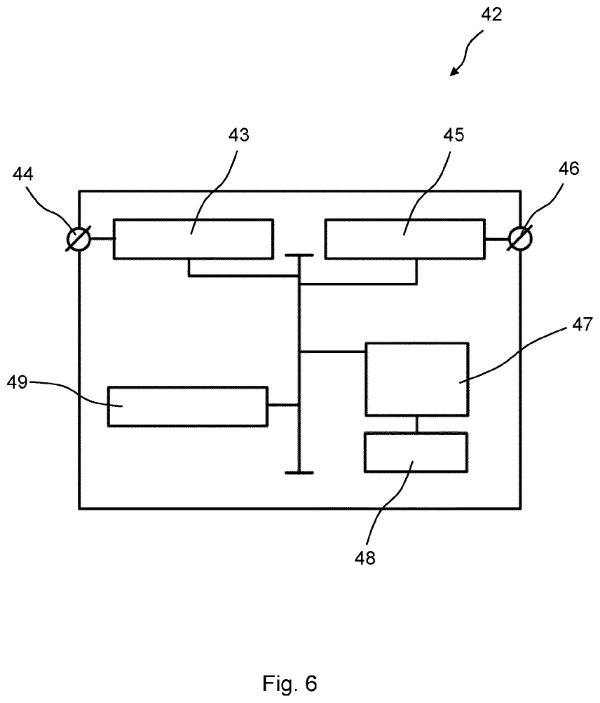

FIG. 6 discloses an example of a source mesh node 42 in accordance with the present disclosure.

The source mesh node 42 is arranged for enabling a coordinated transmission in a wireless mesh network for a transmission of a message from said source mesh node of the wireless mesh network to a destination node.

Here, the wireless mesh network further comprises a plurality of intermediate mesh nodes for relaying said message from said source mesh.

The source mesh node 42 comprises a processor 47 and a memory 48, said memory 48 containing instructions executable by said processor 47.

The source mesh node 42 comprises a receiver 43 connected to a receiving terminal for receiving incoming messages and comprises a transmitter 45 connected to a transmitting terminal for transmitting outgoing messages.

The source mesh node further comprises a broadcast module arranged for broadcasting, in said mesh network, a message intended for said destination node. The broadcasting module may be operated by the processor 47.

The transmitted message comprises coordination information enabling multiple intermediate mesh nodes in said wireless mesh network that receive said message to jointly perform, at a same time, a coordinated transmission towards said destination node. The present disclosure may be useful in the process of keeping track of goods, tools, etc., in reasonably limited areas. For example a large warehouse which stores large amounts of goods, which may be in transit. The descriptor “transit” is used to show that goods is not stored permanently but only for a limited period of time before being shipped to its final destination or some other transit hub. The present disclosure could be used in a more permanent type of storage, however, if there are very few changes to the inventory, keeping track of individual items requires less effort.

All packages may be labelled so that a shipping agent knows where to deliver the package. In a large warehouse, keeping track of package labels manually is very difficult and time consuming. Thus, some shipping companies label the packages with some radio technology, e.g. RFID, so that labels can be read at a distance. Note RFID distance is usually less than 10 m so package inventory may still require manual work. Also, there are other near field communication (NFC) techniques than RFID available.

This is where the present disclosure may be useful since it may rely on the cooperation of several such RFID or NFC labels. By working together in a mesh topology, the total transmission range can be extended until the transmission reaches the intended destination node. It can be so that a package label is preconfigured to provide its position every x hours or days. It can also be so that a package is preconfigured to transmit when it has detected new neighbours. Naturally, the package can be prompted to provide its destination.

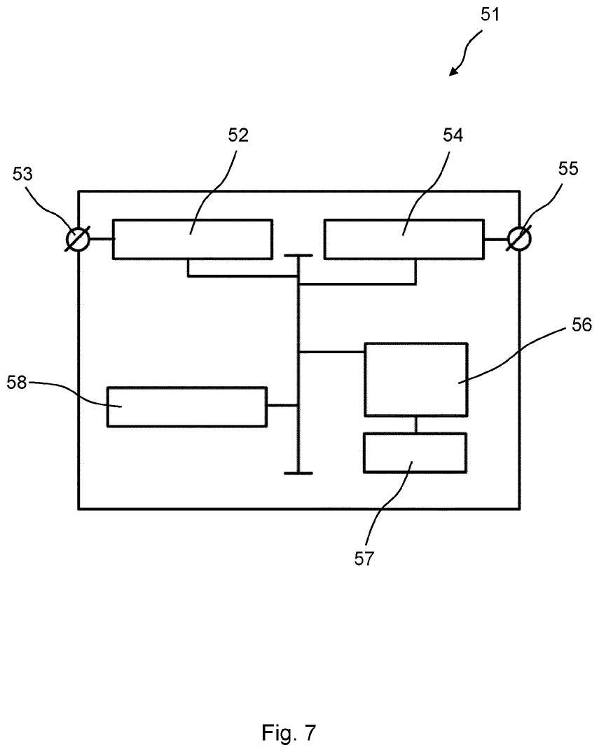

FIG. 7 discloses an example of an intermediate mesh node 51 in accordance with the present disclosure.

The intermediate mesh node 51 is arranged for performing a coordinated transmission in a wireless mesh network for a transmission of a message from a source mesh node of the wireless mesh network to a destination node. The wireless mesh network further comprises a plurality of intermediate mesh nodes for relaying said message from said source mesh node. The intermediate mesh node 51 comprising a processor 56 and a memory 57, said memory 57 containing instructions executable by said processor 56.

The intermediate mesh node 51 further comprising a receiver 52 connected to a receiving terminal 53 and a transmitter 54 connected to a transmitting terminal 55.

The receiver may be arranged for receiving said message broadcasted by said source mesh node and intended for said destination node, wherein said message comprises coordination information enabling multiple intermediate mesh nodes in said wireless mesh network that receive said message to jointly perform, at a same time, a coordinated transmission towards said destination node;

The intermediate mesh node 51 may further comprises a processing unit, of processing module, which is arranged for performing said coordinated transmission based on said coordination information.

The present disclosure may be applicable in the following described scenario. With recent technology it may be possible to attach biodegradable sensors directly to the body of a person. A scenario may be considered where a patient has a number of sensors that logs important medical data. If the patient is immobile, confined to a bed, an NFC setup could directly receive transmissions. However, if the patient is allowed to move around in a larger area individual NFC transmissions would not have a long enough range for reliable transmission of measurement data. In one scenario, the sensor attached to a patient would cooperate as is described in the present disclosure to transmit data. Perhaps, one patient does not have enough sensors, but with the assistance of other patients' sensors the data can be transmitted successfully.

It should be noted that the above-mentioned examples illustrate rather than limit the idea, and that those skilled in the art will be able to design many alternative examples without departing from the scope of the appended claims. The word “comprising” does not exclude the presence of elements or steps other than those listed in a claim, “a” or “an” does not exclude a plurality, and a single processor or other unit may fulfil the functions of several units recited in the claims.

Any reference signs in the claims shall not be construed so as to limit their scope.

1-28. (canceled)

29. A method of enabling a coordinated transmission in a wireless mesh network for a transmission of a message from a source mesh node of the wireless mesh network to a destination node, wherein said wireless mesh network further comprises a plurality of intermediate mesh nodes for relaying said message from said source mesh node to said destination node, wherein the method comprises the step of:
broadcasting, by said source mesh node, in said mesh network, a message intended for said destination node,
wherein said message comprises coordination information enabling multiple intermediate mesh nodes in said wireless mesh network that receive said message to jointly perform, at a same time, a coordinated transmission towards said destination node.

30. The method of claim 29, wherein said destination node is a destination mesh node comprised by said wireless mesh network.

31. The method of claim 29, wherein said coordination information enables multiple intermediate mesh nodes in said wireless mesh network that receive said message at a same hop count from said source mesh node to perform said coordinated transmission.

32. The method of claim 29, wherein said coordination information is any of:
a time-to-next mesh transmission indicating to said intermediate mesh nodes when to relay said message;
a time-to-cooperative mesh transmission indicating to said intermediate mesh nodes when to simultaneously relay said message;
a range of a number of hops away from the source mesh node;
a seed for a random number generator for indicating a delay in relaying said message;
a number of mesh transmissions indicating a number of hops for said message from said source mesh node before performing said coordinated transmission;
a time-to-live counter indicating a remainder of a number of hops for said message from said source mesh node before performing said coordinated transmission;
a trigger to predetermined coordination information indicating how to jointly perform said coordinated transmission.

33. The method of claim 29, wherein said method further comprises the step of:
introducing, by said source mesh node, said coordination information in a header of said message.

34. The method of claim 29, wherein said destination node is an access node of a telecommunication network arranged for operating in said wireless mesh network and arranged for providing access to said telecommunication network.

35. A method of performing a coordinated transmission in a wireless mesh network for a transmission of a message from a source mesh node of the wireless mesh network to a destination node, wherein said wireless mesh network further comprises a plurality of intermediate mesh nodes for relaying said message from said source mesh node to said destination node, wherein the method comprises the step of:
receiving, by an intermediate mesh node of said wireless mesh network, said message broadcasted by said source mesh node and intended for said destination node, wherein said message comprises coordination information enabling multiple intermediate mesh nodes in said wireless mesh network that receive said message to jointly perform, at a same time, said coordinated transmission towards said destination node;
performing, by said intermediate mesh node, said coordinated transmission based on said coordination information.

36. The method of claim 35, wherein said coordination information enables multiple intermediate mesh nodes in said wireless mesh network that receive said message at a same hop count from said source mesh node to perform said coordinated transmission.

37. The method of claim 35, wherein said coordination information is any of:
a time-to-next mesh transmission indicating to said intermediate mesh nodes when to relay said message;
a time-to-cooperative mesh transmission indicating to said intermediate mesh nodes when to simultaneously relay said message;
a seed for a random number generator for indicating a delay in relaying said message;
a range of a number of hops away from the source mesh node;
a number of mesh transmissions indicating a number of hops for said message from said source mesh node before performing said coordinated transmission;
a time-to-live counter indicating a remainder of a number of hops for said message from said source mesh node before performing said coordinated transmission;
a trigger to predetermined coordination information indicating how to jointly perform said coordinated transmission.

38. The method of claim 35, wherein said destination node is an access node of a telecommunication network arranged for operating in said wireless mesh network and arranged for providing access to said telecommunication network.

39. The method of claim 35, wherein said method further comprises the step of:
determining, by said intermediate node, that said relaying of said message by said intermediate node is to be performed using a coordinated transmission, based on said coordination information.

40. A source mesh node arranged for enabling a coordinated transmission in a wireless mesh network for a transmission of a message from said source mesh node of the wireless mesh network to a destination node, wherein said wireless mesh network further comprises a plurality of intermediate mesh nodes for relaying said message from said source mesh, said source mesh node comprising a processor and a memory, said memory containing instructions executable by said processor whereby said source mesh node is configured to:
broadcast, in said mesh network, a message intended for said destination node,
wherein said message comprises coordination information enabling multiple intermediate mesh nodes in said wireless mesh network that receive said message to jointly perform, at a same time, a coordinated transmission towards said destination node.

41. The source mesh node of claim 40, wherein said source mesh node is configured to enable said coordinated transmission in said wireless mesh network for said transmission of said message from said source mesh node of the wireless mesh network to a destination node, said destination node being a destination mesh node of the wireless mesh network.

42. The source mesh node of claim 40, wherein said coordination information is any of:
a time-to-next mesh transmission indicating to said intermediate mesh nodes when to relay said message;
a time-to-cooperative mesh transmission indicating to said intermediate mesh nodes when to simultaneously relay said message;
a seed for a random number generator for indicating a delay in relaying said message;
a number of mesh transmissions indicating a number of hops for said message from said source mesh node before performing said coordinated transmission;
a time-to-live counter indicating a remainder of a number of hops for said message from said source mesh node before performing said coordinated transmission;
a trigger to predetermined coordination information indicating how to jointly perform said coordinated transmission.

43. The source mesh node of claim 40, wherein said source mesh node is further arranged for:
introducing, by said source mesh node, said coordination information in a header of said message.

44. An intermediate mesh node arranged for performing a coordinated transmission in a wireless mesh network for a transmission of a message from a source mesh node of the wireless mesh network to a destination node, wherein said wireless mesh network further comprises a plurality of intermediate mesh nodes for relaying said message from said source mesh node, said intermediate mesh node comprising a processor and a memory, said memory containing instructions executable by said processor whereby said source mesh node is arranged for:
receiving said message broadcasted by said source mesh node and intended for said destination node, wherein said message comprises coordination information enabling multiple intermediate mesh nodes in said wireless mesh network that receive said message to jointly perform, at a same time, a coordinated transmission towards said destination node;
performing said coordinated transmission based on said coordination information.

45. The intermediate node of claim 44, said intermediate node being arranged for performing said coordinated transmission in said wireless mesh network for said transmission of said message from said source mesh node of the wireless mesh network to said destination node, said destination node being a destination mesh node comprised by said wireless mesh network.

46. The intermediate node of claim 44, wherein said coordination information is any of:
a time-to-next mesh transmission indicating to said intermediate mesh nodes when to relay said message;
a time-to-cooperative mesh transmission indicating to said intermediate mesh nodes when to simultaneously relay said message;
a seed for a random number generator for indicating a delay in relaying said message;
a number of mesh transmissions indicating a number of hops for said message from said source mesh node before performing said coordinated transmission;
a time-to-live counter indicating a remainder of a number of hops for said message from said source mesh node before performing said coordinated transmission;
a trigger to predetermined coordination information indicating how to jointly perform said coordinated transmission.

48. The intermediate node of claim 44, wherein said intermediate mesh node is further configured to:
determine that said relaying of said message by said intermediate node is to be performed using a coordinated transmission, based on said coordination information.
